(19) United States
(12) Patent Application Publication
(10) Pub. No.: US 2018/0152071 A1
(43) Pub. Date: May 31, 2018

(54) STATOR

(71) Applicant: TOYOTA JIDOSHA KABUSHIKI KAISHA, Toyota-shi (JP)

(72) Inventors: Yutaka MASUGI, Toyota-shi (JP); Atsushi WATANABE, Toyota-shi (JP); Akihide SHIMMEl, Okazaki-shi (JP)

(73) Assignee: TOYOTA JIDOSHA KABUSHIKI KAISHA, Toyota-shi (JP)

(21) Appl. No.: 15/822,611

(22) Filed: Nov. 27, 2017

(30) Foreign Application Priority Data
Nov. 28, 2016 (JP) 2016-229911

(51) Int. Cl. H02K 3/34; H02K 3/30; H02K 3/48

(52) U.S. Cl. CPC H02K 3/345; H02K 3/48; H02K 3/30

(57) ABSTRACT

A stator 10 includes a stator insulator support 40 includes an outer annular part 41, an inner annular part 45, a plurality of insulator support teeth 50, and a plurality of insulator support slots 51. The stator insulator support 40 is disposed on the stator core 12 in a way positions of the plurality of insulator support slots 51 correspond to positions of a plurality of slots 15. First protrusions 42 protruding toward an axial direction are provided at the same position as the insulator support teeth 50 in a circumferential direction on the outer annular part 41. In each of the first protrusions 42, a first varnish guide groove 42a extending along the circumferential direction for guiding the varnish to the slot 15, and a first coil support surface 42b vertical to the axial direction for regulating movement of a segment coil 30 in the axial direction are formed.

### CROSS REFERENCE TO RELATED APPLICATIONS

This application is based upon and claims the benefit of priority from Japanese patent application No. 2016-229911, filed on Nov. 28, 2016, the disclosure of which is incorporated herein in its entirety by reference.

### BACKGROUND

The present disclosure relates to a stator for a rotary electric machine.

A stator for a rotary electric machine in which segment coils formed by connecting a plurality of conductor segments are attached to a stator core is known. In such a stator, in order to fix the segment coils and radiate heat of the segment coils, varnish treatment is commonly performed. In the varnish treatment, varnish for insulation is impregnated in an entire region between the segment coils attached to the stator core, and then the varnish is hardened.

Incidentally, in the stator described above, a stator insulator support may be disposed on an axial end surface of the stator core. The stator insulator support is for assisting the work of bending the conductor segments constituting the segment coils. The stator insulator support includes an outer annular part, an inner annular part, a plurality of insulator support teeth, and a plurality of insulator support slots. The insulator support teeth radially connect between the outer annular part and the inner annular part. The insulator support slots are formed surrounded by the insulator support teeth adjacent to the outer annular part and the inner annular part in a circumferential direction. Japanese Unexamined Patent Application Publication No. 2016-039712 describes that a stator having such insulator support teeth includes teeth outside placement parts. In the teeth outside placement parts, tapered surfaces inclined toward an axially central side in a direction from a radially outer side toward a radially inner side are provided at the same positions as the insulator support teeth in the circumferential direction. With such a configuration of the stator insulator support, Japanese Unexamined Patent Application Publication No. 2016-039712 states that it is possible to supply more varnish to the part where the stator core and the segment coils are connected.

### SUMMARY

The stator disclosed in Japanese Unexamined Patent Application Publication No. 2016-039712 is subject to a load of the segment coils at the teeth outside placement parts of the stator insulator support. However, if the above-described tapered surfaces are formed at the teeth outside placement parts to be subject to the load of the segment coils, the segment coils cannot be supported well at the tapered surfaces. For this reason, there is a possibility that the segment coils may not be properly positioned with respect to the stator core. Additionally, when the tapered surfaces of the teeth outside placement parts are subject to the load of the segment coils, there is a possibility that an excessive force may be applied to the stator insulator support to thereby damage the stator insulator support.

The present disclosure has been made in view of the above background. An object of the present disclosure is to provide a stator capable of improving reliability of connection between a stator core and segment coils by means of a stator insulator support and capable of properly supporting a load of the segment coils.

An example aspect is a stator including a stator core, a stator insulator support, and a segment coil. The stator core includes: an annular yoke part; a plurality of stator teeth protruding from an inner circumferential surface of the yoke part in a radial direction; and a plurality of slots formed between the adjacent stator teeth. The stator insulator support includes: an outer annular part; an inner annular part; a plurality of insulator support teeth radially connecting between the outer annular part and the inner annular part; a plurality of insulator support slots formed surrounded by the insulator support teeth adjacent to the outer annular part and the inner annular part in the circumferential direction, wherein the stator insulator support is disposed on an axial end surface of the stator core so that the outer annular part is positioned on the yoke part and positions of the plurality of insulator support slots correspond to positions of the plurality of slots, respectively. The segment coil includes a plurality of conductor segments wound around the stator teeth through the slots and the insulator support slots. The segment coil is fixed to the stator core by varnish. first protrusions protruding toward an axial direction are provided at the same positions as the insulator support teeth in an circumferential direction on the outer annular part of the stator insulator support, and in each of the first protrusions, a first varnish guide groove extending along the circumferential direction for guiding the varnish to the slot, and a first coil support surface vertical to the axial direction for regulating movement of the segment coil in the axial direction are formed.

The first coil support surface formed on the first protrusion in the insulator support slot is subject to a load of the segment coil. In the first protrusion of the stator insulator support, the first coil support surface is formed so as to be perpendicular to the axial direction to regulate the movement of the segment coil in the axial direction. It is thus possible to increase a contact area between the segment coil and the first coil support surface. Consequently, a load of the segment coil can be properly supported by the stator insulator support. The varnish landed on the first protrusion flows along the first varnish guide groove extending along the circumferential direction formed in the first protrusion and is guided to the slot. That is, by the first varnish guide groove formed in the first protrusion of the stator insulator support, the varnish can be efficiently supplied into the slot. Since the stator core and the segment coils are close to each other in the part inside the slot into which the segment coil is inserted, the stator core and the segment coil are connected at this part. Therefore, it is possible to improve reliability of the connection between the stator core and the segment coils by efficiently supplying the varnish into the slots with the first varnish guide grooves.

Further, second protrusions protruding toward the axial direction are provided at the same positions as the insulator support teeth in the circumferential direction on the inner annular part of the stator insulator support, and in each of the second protrusions, a second varnish guide groove extending along the circumferential direction for guiding the varnish to the slot, and a second coil support surface vertical to the axial direction for regulating movement of the segment coil in the axial direction are formed.

In the second protrusion of the stator insulator support, the second coil support surface is formed so as to be perpendicular to the axial direction to regulate the movement of the segment coil in the axial direction. It is thus possible to increase a contact area between the segment coil and the second coil support surface. Together with the first coil support surfaces formed on the first protrusions, the second coil support surfaces formed on the second protrusions are subject to the load of the segment coil. In this way, the load of the segment coils can be more properly supported by the stator insulator support. In the insulator support slots, by forming the first varnish guide grooves extending along the circumferential direction in the first protrusions and forming the second varnish guide grooves in the second protrusions, it is possible to more efficiently supply the varnish into the part where the stator core is connected to the segment coils. This contributes to improve reliability of the connection between the stator core and the segment coils.

According to the present disclosure, it is possible to improve the reliability of connection between a stator core and segment coils by means of a stator insulator support and to properly support a load of the segment coils.

The above and other objects, features and advantages of the present invention will become more fully understood from the detailed description given hereinbelow and the accompanying drawings which are given by way of illustration only, and thus are not to be considered as limiting the present invention.

### BRIEF DESCRIPTION OF DRAWINGS

FIG. 1 is a perspective view showing a configuration of a stator according to an embodiment;

FIG. 2 is an external view of a conductor segment constituting a segment coil of the stator according to the embodiment;

FIG. 3 is a plan view showing a configuration of a stator insulator support of the stator according to the embodiment;

FIG. 4 is an enlarged perspective view showing a region surrounded by a broken line A of FIG. 3;

FIG. 5 is a cross-sectional diagram taken along the line V-V of FIG. 3;

FIG. 6 is an enlarged perspective view showing a stator insulator support according to Modified Example 1 corresponding to FIG. 4; and

FIG. 7 is a cross-sectional diagram taken along the line VII-VII of FIG. 6.

### DESCRIPTION OF EMBODIMENTS

Hereinafter, an embodiment of the present disclosure will be described with reference to the drawings.

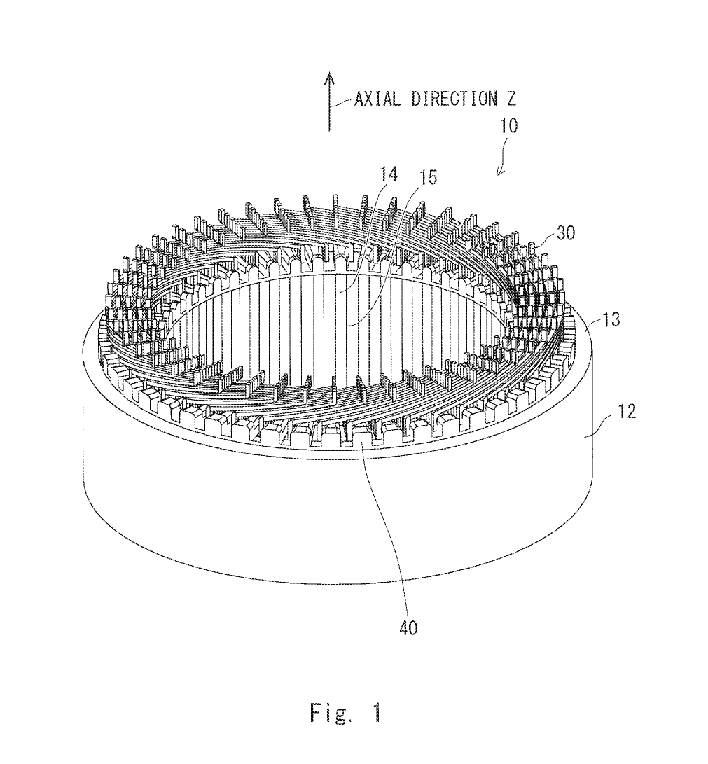

First, a configuration of a stator 10 of a rotary electric machine according to this embodiment will be described with reference to FIG. 1. FIG. 1 is a perspective view showing a configuration of the stator 10 according to this embodiment. In FIG. 1, the stator 10 is shown in a state in which an axial direction Z is oriented in the vertical direction (vertical direction in FIG. 1). In FIG. 1, the stator 10 is oriented differently from an actual usage orientation by 90 degrees. As shown in FIG. 1, the stator 10 includes a stator core 12, a stator insulator support 40, and segment coils 30.

The stator core 12 is formed by layering a plurality of electromagnetic steel sheets, which are disc shaped magnetic materials, in an axial direction. The stator core 12 includes an annular yoke part 13 and a plurality of stator teeth 14 that protrude toward a radial direction from a plurality of positions on an inner peripheral surface of the yoke part 13 in the circumferential direction. The stator core 12 further includes a plurality of slots 15 formed between the adjacent stator teeth 14.

The stator insulator support 40 is disposed on an axial end surface of the stator core 12 (an upper end surface in FIG. 1). Details of the stator insulator support 40 will be described later. The segment coil 30 includes a plurality of conductor segments 31, which will be described later. The plurality of conductor segments 31 are wound around the stator teeth through slots 15 and insulator support slots 51, which will be described later.

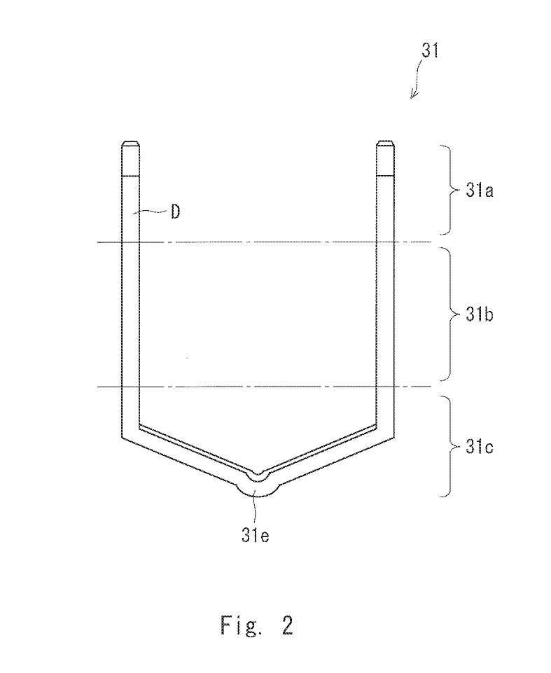

FIG. 2 is an external view of the conductor segment 31 constituting the segment coils 30 (see FIG. 1). As shown in FIG. 2, the conductor segment 31 is formed by shaping a flat square conductor D having a rectangular section in a substantially U shape by edgewise bending and applying an insulating coating to a surface of the conductor D. The conductor segment 31 includes a lead distal end part 31a, an in-slot conductor part 31b, and a counter lead part 31c. The lead distal end part 31a is a part that protrudes from the axial end surface of the stator core 12 shown in FIG. 1 (the upper end surface in FIG. 1). The insulating coating comes off from a distal end of the lead distal end part 31a The in-slot conductor part 31b is a part to be inserted into the slot 15 of the stator core 12 shown in FIG. 1. The counter lead part 31c is a part positioned on another end side of the stator core 12 in the axial direction (a lower side in FIG. 1). A crank-shaped crank part 31e is formed in the counter lead part 31c.

In the stator core 12 (see FIG. 1), the plurality of conductor segments 31 shown in FIG. 2 are inserted into two slots 15 that are separated from each other in the circumferential direction with a plurality of slots 15 interposed therebetween in a state in which the plurality of the conductor segments 31 are aligned in the radial direction of the stator core 12. The lead distal end part 31a of the conductor segment 31 shown in FIG. 2, namely, a part protruding from the axial end surface of the stator core 12 (see FIG. 1), is bent so as to incline toward the axial direction of the stator core 12. The stator insulator support 40, which will be described later, is for assisting the work of bending the lead distal end parts 31a of the conductor segments 31. After the lead distal end parts 31a of the conductor segments 31 are bent, the conductor segments 31 adjacent to each other in the radial direction are welded and connected to each other at the parts where the coatings of the lead distal end parts 31a come off. Then, the segment coils 30 (see FIG. 1) are formed. Further, the segment coils 30 are fixed to the stator core 12 by varnish.

Next, a configuration of the stator insulator support 40 will be described. Note that in the following description, reference will also be made to FIG. 1 as appropriate.

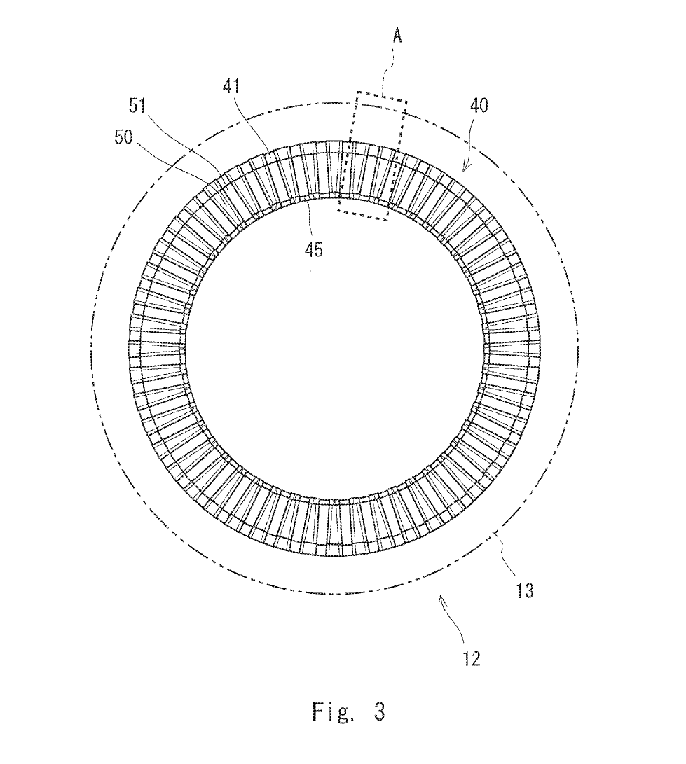

FIG. 3 is a plan view showing a configuration of the stator insulator support 40. As shown in FIG. 3, the stator insulator support 40 includes an annular-shaped outer annular part 41, an annular-shaped inner annular part 45 having the same central axis as that of the outer annular part 41, and a plurality of insulator support teeth 50 radially connecting between the outer annular part 41 and the inner annular part 45. The stator insulator support 40 includes a plurality of insulator support slots 51 which are rectangular elongated holes formed surrounded by the insulator support teeth 50 that are adjacent to the outer annular part 41 and the inner annular part 45 in the circumferential direction. The stator insulator support 40 is non-magnetic and is made of a resin material such as PPS (Poly Phenylene Sulfide). In the stator insulator support 40, the outer annular part 41 is positioned on the yoke part 13 of the stator core 12.

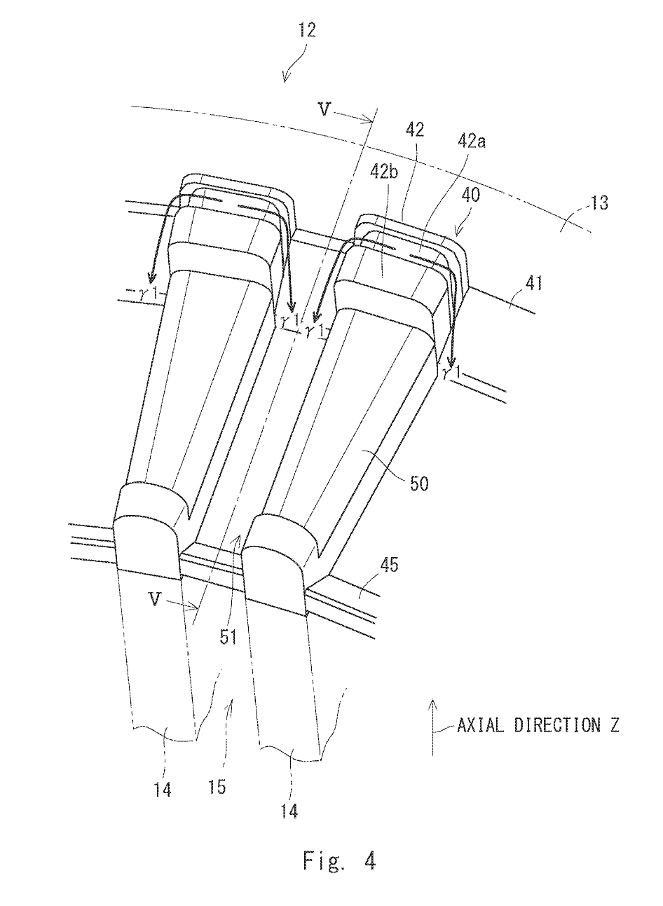

FIG. 4 is an enlarged view showing a region surrounded by a broken line A in FIG. 3. As shown in FIG. 4, the stator insulator support 40 is disposed on the axial end surface of the stator core 12 so that the positions of the plurality of insulator support slots 51 correspond to the positions of the plurality of slots 15, respectively. That is, the insulator support slots 51 communicate with axial opening ends of the corresponding slots 15. As described above, the plurality of conductor segments 31 (see FIG. 2) are wound around the stator teeth through the slots 15 and the insulator support slots 51. The insulator support teeth 50 of the stator insulator support 40 are formed in a semicircular shape. The lead distal end part 31a (see FIG. 2) of the conductor segment 31 is bent while in contact with the arc-shaped curved part of the insulator support teeth 50.

As shown in FIG. 4, first protrusions 42 protruding toward the axial direction are provided on the outer annular part 41 of the stator insulator support 40 at the same positions as those of the insulator support teeth 50 in the circumferential direction. The first protrusions 42 are in a quadrangular prism shape. Both upper ends of the first protrusions 42 in the circumferential direction are chamfered so that the upper ends are arc-shaped when viewed from the radial direction. Further, first coil support surfaces 42b that are vertical in the axial direction are formed on the first protrusions 42 in order to regulate movement of the segment coils 30 (see FIG. 1) in the axial direction. In each of the first protrusions 42, a first varnish guide groove 42a is formed along the circumferential direction for guiding the varnish to the slot 15 through the insulator support slot 51. Note that the inner annular part 45 may include protrusions protruding toward the axial direction at the same positions as those of the insulator support teeth 50 in the circumferential direction.

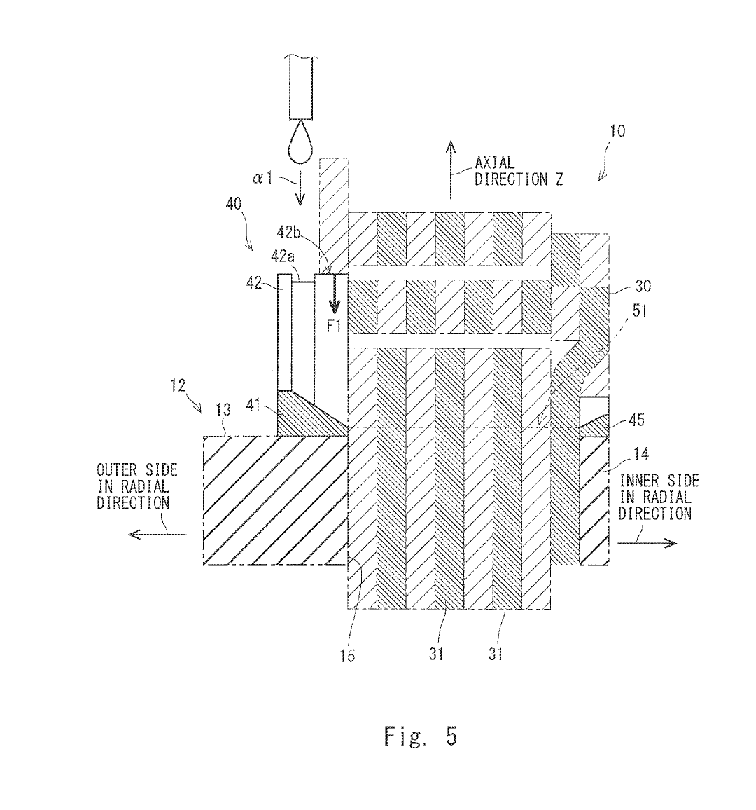

FIG. 5 is a cross-sectional diagram taken along the line V-V of FIG. 4. As shown in FIG. 5, the first coil support surface 42b formed on the first protrusion 42 in the insulator support slot 51 is subject to a load F1 of the segment coil 30. In the first protrusion 42 of the stator insulator support 40, the first coil support surface 42b is formed so as to be perpendicular to the axial direction to regulate the movement of the segment coil 30 in the axial direction. It is thus possible to increase a contact area between the segment coil 30 and the first coil support surface 42b. Consequently, the load of the segment coil can be properly supported by the stator insulator support 40.

As described above, the segment coils 30 are fixed to the stator core 12 by varnish. As shown in FIG. 5, when the segment coils 30 are fixed to the stator core 12, the axial direction of the stator core 12 is aligned with that of the segment coils 30 in the vertical direction by means of the stator insulator support 40. Then, in this state, the varnish is dropped from above as indicated by the arrow α1.

As shown in FIGS. 4 and 5, the varnish landed on the first protrusion 42 flows along the first varnish guide groove 42a as indicated by the arrow γ1 and is guided to the slot 15 through the insulator support slot 51. That is, by the first varnish guide groove 42a formed in the first protrusion 42, the varnish can be efficiently supplied into the slot 15. Since the stator core 12 and the segment coils 30 are close to each other in the part inside the slot 15 into which the segment coil 30 is inserted, the stator core 12 and the segment coil 30 are connected at this part. Therefore, it is possible to improve reliability of the connection between the stator core 12 and the segment coils 30 by efficiently supplying the varnish into the slots 15 with the first varnish guide grooves 42a.

### Modified Example 1

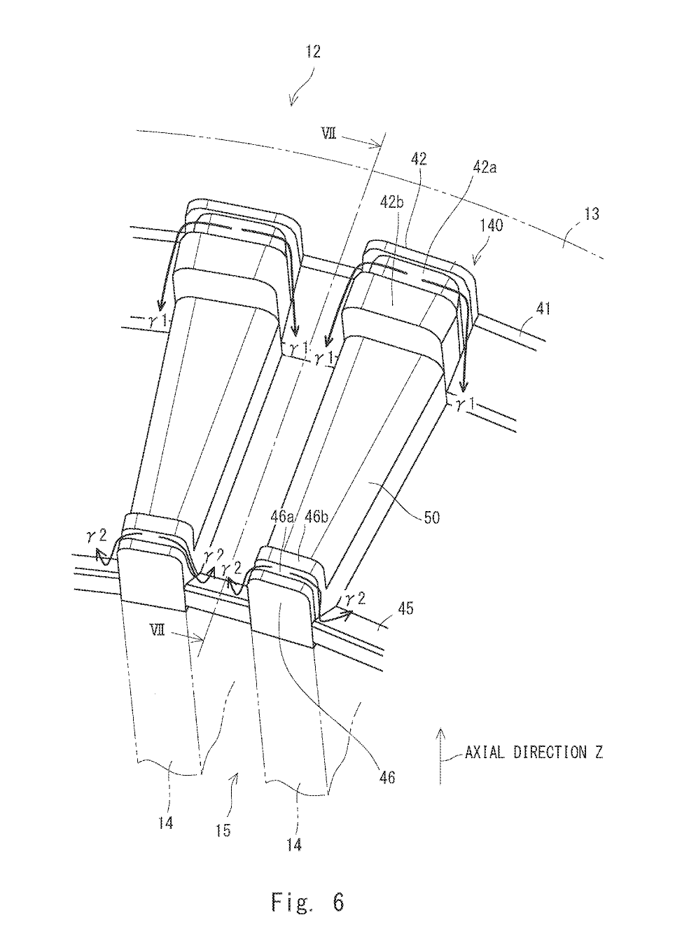

FIG. 6 is an enlarged view of a stator insulator support 140 according to Modified Example 1 corresponding to FIG. 4. As shown in FIG. 6, second protrusions 46 protruding toward the axial direction are provided on the inner annular part 45 of the stator insulator support 140 at the same positions as those of the insulator support teeth 50 in the circumferential direction. The configuration of the second protrusions 46 provided on the inner annular part 45 is basically the same as that of the first protrusions 42 provided on the outer annular part 41. That is, the second protrusions 46 are in a quadrangular prism shape. Further, both upper ends of the second protrusions 46 in the circumferential direction are chamfered so that the upper ends are arc-shaped when viewed from the radial direction. Furthermore, first coil support surfaces 42b that are vertical in the axial direction are formed on the second protrusions 46 in order to regulate movement of the segment coils 30 in the axial direction. In each of the second protrusions 46, a second varnish guide groove 46a is formed along the circumferential direction for guiding the varnish to the insulator support slot 51.

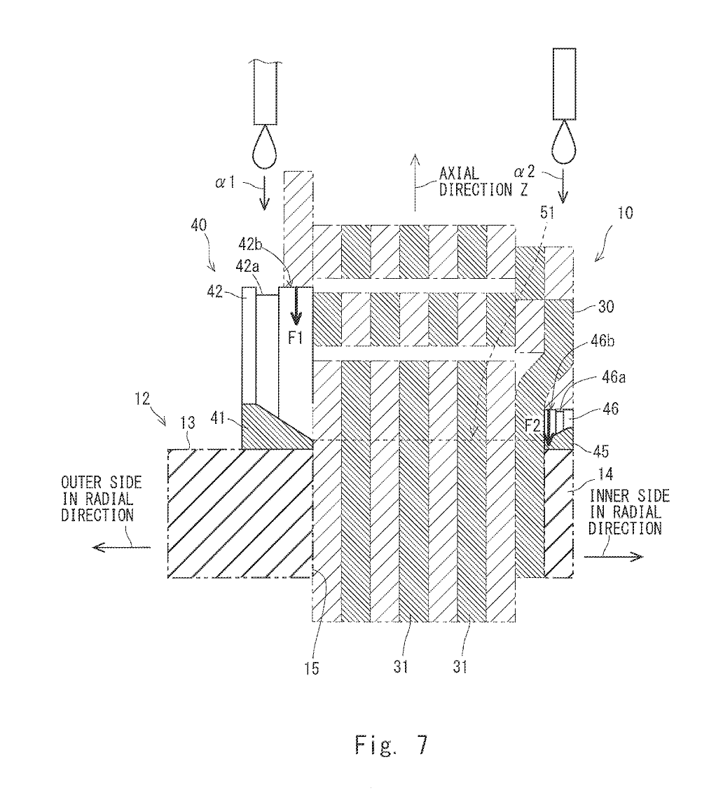

FIG. 7 is a cross-sectional diagram taken along the line VII-VII of FIG. 6. As shown in FIG. 7, the second coil support surface 46b formed on the second protrusion 46 in the insulator support slot 51 is in contact with the segment coil 30 and is subject to a load F2 of the segment coil 30. In the second protrusion 46 of the stator insulator support 40, the second coil support surface 46b is formed so as to be perpendicular to the axial direction to regulate the movement of the segment coil 30 in the axial direction. It is thus possible to increase a contact area between the segment coil 30 and the second coil support surface 46b. Together with the first coil support surfaces 42b formed on the first protrusions 42, the second coil support surfaces 46b formed on the second protrusions 46 are subject to the load of the segment coil 30. In this way, the load of the segment coils can be more properly supported by the stator insulator support 40.

As shown in FIG. 7, when the segment coils 30 are fixed to the stator core 12, the axial direction of the stator core 12 is aligned with that of the segment coils 30 in the vertical direction by means of the stator insulator support 140. In this state, the varnish is dropped from above as indicated by the arrow α2.

As shown in FIGS. 6 and 7, the varnish landed on the second protrusion 46 flows along the second varnish guide groove 46a as indicated by the arrow γ2 and is guided to the slot 15 through the insulator support slot 51. By forming the first varnish guide groove 42a in the first protrusion 42 and forming the second varnish guide groove 46a in the second protrusion 46, it is possible to more efficiently supply the varnish into the slot 15. As described above, since the stator core 12 and the segment coils 30 are close to each other in the part inside the slot 15 into which the segment coil 30 is inserted, the stator core 12 and the segment coil 30 are connected at this part. Therefore, by configuring the stator insulator support 140 as in this modified example, the varnish can be more efficiently supplied into the slots 15. This contributes to improve reliability of the connection between the stator core 12 and the segment coils 30

Note that the present disclosure is not limited to the above embodiments, and modifications may be made as appropriate without departing the scope thereof.

From the invention thus described, it will be obvious that the embodiments of the invention may be varied in many ways. Such variations are not to be regarded as a departure from the spirit and scope of the invention, and all such modifications as would be obvious to one skilled in the art are intended for inclusion within the scope of the following claims.

What is claimed is:

1. A stator comprising:
a stator core comprising:
an annular yoke part;
a plurality of stator teeth protruding from an inner circumferential surface of the yoke part in a radial direction; and
a plurality of slots formed between the adjacent stator teeth;
a stator insulator support comprising:
an outer annular part;
an inner annular part;
a plurality of insulator support teeth radially connecting between the outer annular part and the inner annular part;
a plurality of insulator support slots formed surrounded by the insulator support teeth adjacent to the outer annular part and the inner annular part in the circumferential direction, wherein the stator insulator support is disposed on an axial end surface of the stator core so that the outer annular part is positioned on the yoke part and positions of the plurality of insulator support slots correspond to positions of the plurality of slots, respectively; and
a segment coil comprising a plurality of conductor segments wound around the stator teeth through the slots and the insulator support slots, wherein
the segment coil is fixed to the stator core by varnish, and
first protrusions protruding toward an axial direction are provided at the same positions as those of the insulator support teeth in an circumferential direction on the outer annular part of the stator insulator support, and in each of the first protrusions, a first varnish guide groove extending along the circumferential direction for guiding the varnish to the slot, and a first coil support surface vertical to the axial direction for regulating movement of the segment coil in the axial direction are formed.

2. The stator according to claim 1, wherein second protrusions protruding toward the axial direction are provided at the same positions as those of the insulator support teeth in the circumferential direction on the inner annular part of the stator insulator support, and in each of the second protrusions, a second varnish guide groove extending along the circumferential direction for guiding the varnish to the slot, and a second coil support surface vertical to the axial direction for regulating movement of the segment coil in the axial direction are formed.
